(19) United States
(12) Patent Application Publication
(10) Pub. No.: US 2010/0295717 A1
(43) Pub. Date: Nov. 25, 2010

(54) WEAPON DETECTION AND ELIMINATION SYSTEM

(76) Inventor: Christopher J. Rourk, Dallas, TX (US)

Correspondence Address: Mr. Christopher John Rourk;Jackson Walker LLP, 901 Main Street, Suite 6000, DALLAS, TX, 75202, US

(21) Appl. No.: 12/845,508

(22) Filed: Jul. 28, 2010

Related U.S. Application Data
(63) Continuation-in-part of application No. 11/953,942, filed on Jan. 29, 2008, now Pat. No. 7,768,444.

(51) Int. Cl. G01S 13/86

(52) U.S. Cl. 342/13; 342/67

(57) ABSTRACT

A system for causing an electrical effect in a weapon. A system for detecting a location and a size of a weapon. A system for transmitting electromagnetic radiation towards the weapon at a frequency and a vector orientation to optimize generation of electrical effects in the weapon.

### RELATED APPLICATIONS

This application is a continuation-in-part of and claims priority to U.S. application Ser. No. 11/953,942, entitled “Weapon Detection and Elimination System,” filed Jan. 29, 2008, which is hereby incorporated by reference in its entirety for all purposes.

### FIELD OF THE INVENTION

The present invention pertains to the field of weapons detection systems, and more particularly to a system for the detection of weapons using radar and elimination of detected weapons utilizing an energy field that is tuned to objects having a size and material composition of ammunition for the detected weapons.

### BACKGROUND OF THE RELATED ART

Radar detection systems for detecting weapons and energy field systems are know in the art. Radar detection systems can detect the presence and location of weapons, and energy field systems can generate energy fields having predetermined frequency and energy characteristics.

### SUMMARY OF THE INVENTION

In accordance with the present invention, a system for detecting and eliminating weapons is provided that utilizes weapons detecting radar systems and energy field systems.

In accordance with an exemplary embodiment of the present invention, a system for causing an electrical effect in a weapon is provided, which includes a system for detecting a location and a size of a weapon, and a system for transmitting electromagnetic radiation towards the weapon at a frequency (such as a resonant frequency) and a vector orientation (such as in direct phase with the resonant structure) to optimize generation of electrical effects in the weapon.

Those skilled in the art will further appreciate the advantages and superior features of the invention together with other important aspects thereof on reading the detailed description that follows in conjunction with the drawings.

### BRIEF DESCRIPTION OF THE SEVERAL VIEWS OF THE DRAWINGS

FIG. 1 is a diagram of a system for detecting weapons and detonating ammunition in the vicinity of the weapon in accordance with an exemplary embodiment of the present invention;

FIG. 2 is a diagram of a system for a radar weapon detection system 200 in accordance with an exemplary embodiment of the present invention;

FIG. 3 is a diagram of a system for controlling an energy field in accordance with an exemplary embodiment of the present invention;

FIG. 4 is a diagram of method for detecting and detonating weapons and ammunition in accordance with an exemplary embodiment of the present invention; and

FIG. 5 is a diagram of a map identifying the location of weapons relative to the location of friendly forces in accordance with an exemplary embodiment of the present invention;

FIG. 6 is a flow chart of a method for tuning an energy field to a resonant frequency of a target in accordance with an exemplary embodiment of the present invention;

FIG. 7 is a flow chart of a method for tracking a location of a weapon in accordance with an exemplary embodiment of the present invention;

FIG. 8 is a diagram 800 showing decay of a transmitted signal strength in a metallic object that has been excited at a resonant frequency;

FIG. 9 is a diagram 900 showing frequency components of reflected broadband radio frequency radiation that can be used to detect resonant frequencies;

FIG. 10 is a diagram 1000 showing an exemplary voltage magnitude of standing voltage waves;

FIG. 11 is a diagram of an active shield in accordance with an exemplary embodiment of the present invention;

FIG. 12 is a diagram of a method for frequency searching in accordance with an exemplary embodiment of the present invention;

FIG. 13 is a diagram of a multiple beam pattern in accordance with an exemplary embodiment of the present invention;

FIG. 14 is a diagram of a shock frequency timing diagram in accordance with an exemplary embodiment of the present invention; and

FIG. 15 is a diagram of two exemplary experimental embodiments of the present invention that demonstrate the inventive concept.

### DETAILED DESCRIPTION OF THE INVENTION

In the description that follows, like parts are marked throughout the specification and drawings with the same reference numerals, respectively. The drawing figures might not be to scale, and certain components can be shown in generalized or schematic form and identified by commercial designations in the interest of clarity and conciseness.

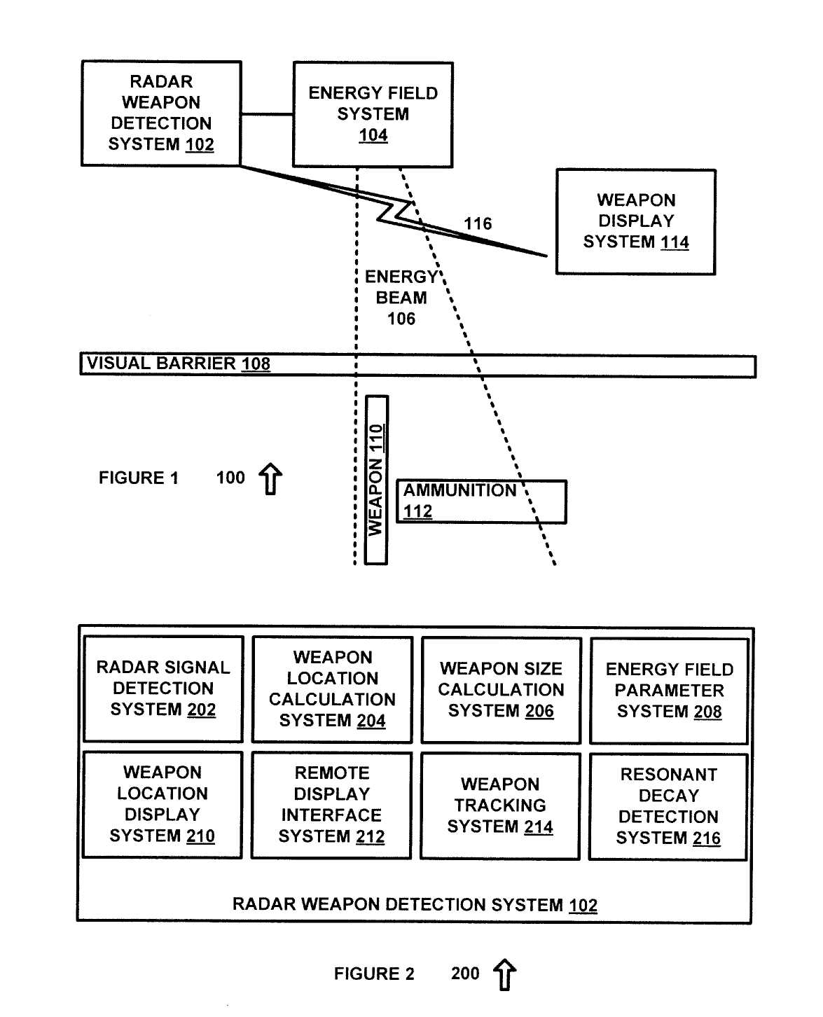

FIG. 1 is a diagram of a system 100 for detecting weapons and detonating ammunition in the vicinity of the weapon in accordance with an exemplary embodiment of the present invention. System 100 can be used by army personnel, police, or other personnel to detect and neutralize hidden threats.

System 100 includes radar weapon detection system 102, which generates a radar signal, which is understood to be a radio frequency electromagnetic field having a frequency and waveform, and receives reflected indications from metallic objects, which reflect the radio frequency electromagnetic field, and which may change characteristics of the frequency and waveform, such as by changing phase, waveform and other characteristics. The reflected signal also arrives at a time related to the distance of the metallic object from the radar signal source, such that the time between when the signal is transmitted and when the reflection is received can be used to determine the distance to the metallic object. Radar weapon detection system 102 includes a radar signal transmitter transmitting a radar signal and an antenna receiving a reflected signal, and processes the reflected signals and determines a size and location of metallic weapons such as guns, rifles, or other metallic weapons. In one exemplary embodiment, radar weapon detection system 102 can be used with only an antenna where energy field system 104 is used to transmit a signal that generates reflected signals that are analyzed to detect a weapon, ammunition, or other suitable items.

In one exemplary embodiment, the transmitted radar signal can include a pulse having a large number of frequency components. While a Dirac-delta function having a constant frequency domain value would provide an ideal signal to detect resonant frequencies of metallic objects, a practical application of a Dirac-delta function will have a large number of frequency components, which will be highly likely to excite a resonant mode of a metallic object. Resonant modes can exist in metallic objects wherever a conducting path exists having a length equal to a wavelength corresponding to the transmitted frequency of the radar signal, such that a transmitted pulse having a large number of frequency components would likely excite a number of resonant frequencies in metallic objects.

For example, consider a metallic tube having a length L, a wall thickness T and an outer diameter D. A number of resonant modes will exist ranging from wavelengths having a length L to wavelengths having a length of (L²+D²)^{1/2}. The conductivity of the metallic object, resonant frequency, skin depth of the conducted signal at the resonant frequency and a number of other factors will also affect the quality of the resonant signal in the metallic object.

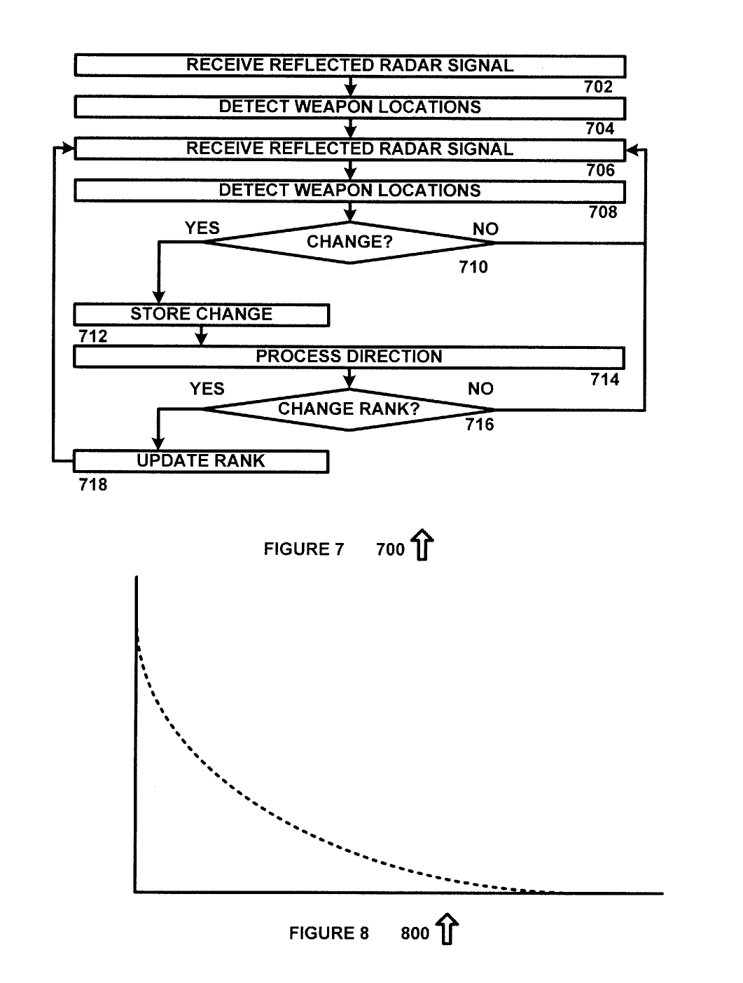

One aspect of a signal generated from a metallic object that has been excited at a resonant frequency that is different from a reflected radio frequency electromagnetic field from a metallic object is that the resonant signal may continue for a period of time that is longer than the reflected signal. This can be seen in diagram 800 of FIG. 8, showing decay of a transmitted signal strength in a metallic object that has been excited at a resonant frequency. Instead of a simple reflected waveform, the resonant oscillations from the metallic object continues to persist until the energy stored in the resonant field is dissipated by radiation, heating or other loss functions. As such, a Fourier transform of a received signal at successive periods of time can be used to distinguish between a reflected signal and a radiated signal from resonant structure, as shown in FIG. 9, for a transmitted signal having a large number of frequency components. For example, frequency components F1, F3, F4 and F5 can be determined to be reflected signals, where the time of reception T=X or T=X+δ can be used to determine the distance from the metallic object, as well as some characteristics of the metallic object. However, the fact that these frequency components lack corresponding elements at the different times distinguishes them from the two frequency components at F2, with a decreasing magnitude from time T=X to T=X+δ. The decay rate of a resonant signal on a conductor may decay exponentially, and verification of an exponential decay rate can be used to determine or verify that a resonant signal is being measured.

Energy field system 104 receives weapon size and location data and generates an energy field 106 that is tuned to resonate weapons or ammunition associated with the detected weapon. In one exemplary embodiment, a detected weapon can be used with predetermined types and sizes of ammunition, which are generally located in the vicinity of the detected weapon. Energy field system 104 directs an energy field 106 towards detected weapons having frequency and energy characteristics to cause the weapon to resonate so as to heat the weapon until it cannot be held or is damaged, or to heat the ammunition to cause it to detonate, thus neutralizing the ammunition and potentially neutralizing personnel in the vicinity of such ammunition. In addition, visual and audio reports of such ammunition detonations can provide personnel with an indication of where the associated weapons and personnel are located. Suitable energy fields such as microwave fields, microwave lasers, or other suitable fields can be used.

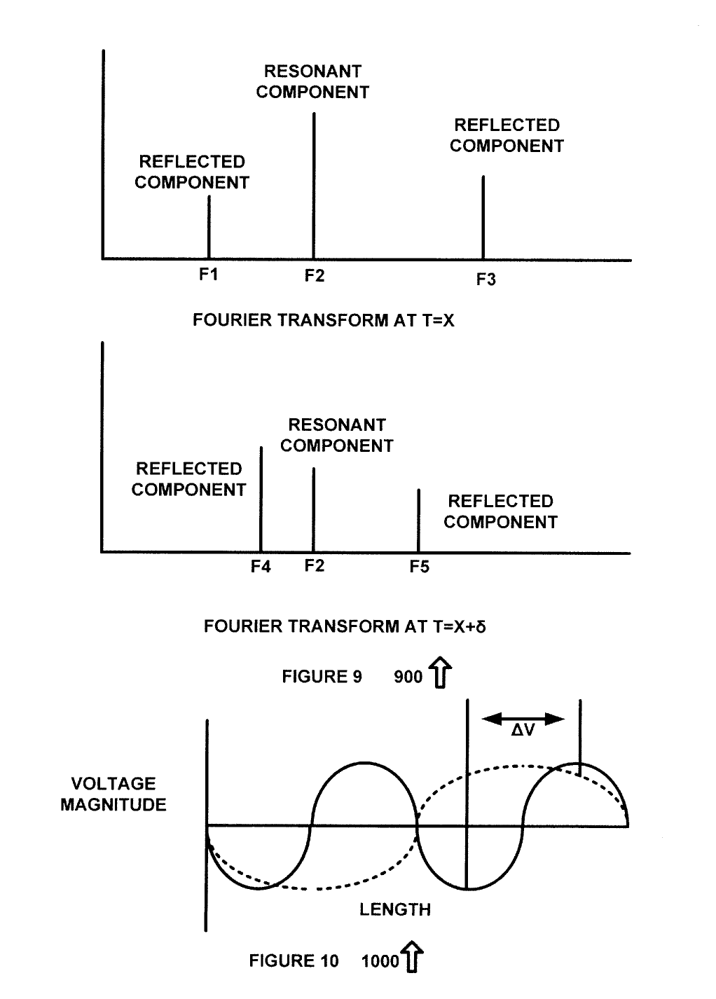

In one exemplary embodiment, a standing wave voltage such as shown in FIG. 10 can be induced, where the magnitude of the voltage continues to increase as long as the metallic conductor, such as a weapon, is exposed to an electromagnetic field. For example, an ideal conductor that is one meter in length that is exposed to an RF field having a frequency of 299.79 MHz will develop a standing wave voltage that increases each cycle. Thus, if the field strength is 1 volt/meter, the voltage magnitude will increase to 100,000 volts in 100,000 cycles, or 333 microseconds. A real conductor will introduce a number of loss factors that will damp the voltage magnitude increase, such as resistive heating generated by the induced current and the resistance resulting from the skin depth of the conductor, capacitive and inductive coupling to other metallic objects or to ground, the high impedance path to ground presented by the person holding the conductor/weapon, and other loss mechanisms. It may also be necessary to control the induced voltage to avoid delivering a lethal shock to the person holding the weapon/conductor, such as by controlling the field strength, by controlling the length of time the field is emitted, or in other suitable manners. Different harmonic frequencies can also or alternatively be used, such as to generate voltage differentials at desired locations. For example, a shell contained within the magazine or breech chamber might be shielded by the barrel of the weapon, and thus may provide a conducting path between two different parts of the weapon that are at different potentials. In this manner, detonation of a shell that is contained within a weapon might be caused through the use of a higher harmonic of the resonant frequency. In FIG. 10, a fundamental frequency voltage is shown with a dotted line, and a second harmonic frequency is shown with a solid line. Between the two points identified as ΔV, it can be seen that the difference in voltage magnitude is much greater for the second harmonic frequency than for the fundamental frequency, such that if a person is holding the weapon at those two points, a more significant voltage difference can be delivered at the second harmonic frequency than at the fundamental frequency. A user control can be provided, such as in field tuning system 304 or in other suitable systems, to allow a user to select different harmonics, a sequence of harmonic frequencies can be generated to create different voltage differentials at different points, or other suitable processes can be utilized.

Visual barrier 108 obscures the location of weapon 110 and ammunition 112. Because visual barrier 108 prevents weapon 110 and ammunition 112 from visual detection, radar weapon detection system 102 and energy field system 104 can be used to locate and neutralize the threat presented by personnel in the vicinity of weapon 110. Likewise, where such personnel are not present, radar weapon detection system 102 and energy field system 104 can be used to detected caches of hidden weapons and ammunition.

Weapon display system 114 displays weapons detected by radar weapon detection system 102, such as to allow a user to determine the location of potential threats, to subjectively rank threats, or for other suitable purposes. Weapon display system 114 can be integral with radar weapon detection system 102, can be operated remotely using wireless link 116, or can be used in other suitable manners.

In operation, system 100 can be used by military personnel, police or other personnel to detect and neutralize potential threats, weapons caches, or other weapons. In one exemplary embodiment, system 100 can be used by military personnel who are operating in an urban area, such as where insurgents are hiding with weapons such as rocket-propelled grenades, surface to air projectiles, or other weapons. System 100 allows such insurgents or enemy operatives to be detected and neutralized, such as by destroying their weapons or ammunition, causing injury to the insurgents when weapons are heated or ammunition detonates, or by generating a visual and audible report that can be detected and used to track the location of the insurgents and associated weapons.

FIG. 2 is a diagram of a system 200 for a radar weapon detection system 200 in accordance with an exemplary embodiment of the present invention. System 200 includes radar signal detection system 202, weapon location calculation system 204, weapon size calculation system 206, energy field parameter system 208, weapon location display system 210, remote display interface system 212, weapon tracking system 214 and resonant decay detection system 216, each of which can be implemented in hardware, software, or a suitable combination of hardware and software, and which can be one or more software systems operating on a general purpose processing platform.

Radar signal detection system 202 receives reflected radar signals and detects objects corresponding to the reflected signals. In one exemplary embodiment, the size, dimensions, composition and other parameters of an object can be detected, such as by using the energy and frequency parameters of the transmitted radar energy and the energy and frequency parameters of detected reflections to determine the parameters of an object that generated the reflected energy. For example, when a metallic object is illuminated with a high frequency energy source, it will generate a reflected signal based on the resistivity of the metal, the size and shape of the metal, and other parameters of the metal object. Based on the reflected signal, the location and other parameters of a metallic object can be determined. Likewise, weapons can also be distinguished from non-weapon materials based on the waveform of the reflected signal, which can be used to determine the material properties of the detected object.

Weapon location calculation system 204 calculates a location of a weapon based on reflected radar signals and resonant signals. The direction and distance of a weapon relative to radar weapon detection system 102 can be determined based on the length of time it takes to generate and receive the reflected signal, the frequency and energy characteristics of the reflected signal, the shape of the waveform of the reflected signal relative to the excitation signal, and other parameters. In one exemplary embodiment, a metallic object that is excited at a resonant frequency will generate a return RF signal that is different from a reflected RF signal, such that the actual size of the metallic object can be detected as opposed to just the radar cross section. In addition, the vector orientation of the RF signal that excites the resonant oscillation mode of the metallic object will control the parameters of the received signal emitted from the resonant metallic object. For example, a linear conductor that is in direct phase with an illuminating RF field and that is excited at a resonant frequency will radiate a return RF field at a vector that is 90 degrees from the vector of the illuminating RF field. A linear conductor that is 30 degrees out of phase with an illuminating RF field and that is excited at a resonant frequency will radiate a return RE field at a first vector that is 150 degrees from the vector of the illuminating RF field and a second vector that is degrees from the vector of the illuminating RF field. In this exemplary embodiment, the first vector will be directed back towards the RF field source whereas the second vector will be directed away from the RF field source. Radar signal receivers at different locations from the RF signal emitters can be used to detect the orientation of resonant emitters that are in phase with the RF signal emitter, whereas the vector of any return resonant signal from a receiver that is co-located with the RF field source can be used to detect the orientation of other resonant emitters.

Weapon size calculation system 206 receives reflected radar signal data and determines weapon size characteristics. In one exemplary embodiment, a smaller weapon will generate a smaller reflected signal than a larger weapon, weapons made out of different materials will generate different wave shapes of reflected signals, and other parameters of the reflected signal can be used to calculate a weapon size based on a reflected radar signal.

Energy field parameter system 208 generates energy field parameters based on detected weapon size and location. In one exemplary embodiment, a weapon size can be used to determine the frequency of energy that will cause a resonant wave to circulate in the weapon, or the frequency of energy required to heat associated ammunition for the weapon, such as where the weapon has a copper shell, a fragmenting metallic casing, or other characteristics. For detected weapons that are farther away, a narrower field dimension can be generated whereas for closer weapons, a wider field can be generated. The length of time required to illuminate a weapon and associated ammunition can also be varied as a function of field size and the distance between the energy field and the weapon. Likewise, energy field parameter system 208 can adjust energy field parameters such as frequency, based on a search algorithm that maximizes the energy field at a resonant frequency of a weapon, ammunition, or other suitable targets. In one exemplary embodiment, energy field frequency can be adjusted and the reflected energy can be monitored to detect an increase in reflected energy that is indicative of an increasing level of excitation, such as where the weapon, ammunition or other target is approaching resonance. In this exemplary embodiment, a search algorithm such as the following can be used:

F(N+1)=F(N)+/−X*(F(N))

where F(N) is a current frequency characteristic of the energy field, X is a variable based on a search parameter, and F(N+1) is the new energy beam frequency characteristic. In this exemplary embodiment, the initial frequency of the energy field can be selected from a table of resonant frequency targets associated with a weapon or ammunition that is used by the weapon, and the amount of variation in the energy field frequency can be selected based on responses to changes in measured reflected signals. For example, if a weapon is detected and is illuminated with an energy field at an expected resonant frequency of the weapon, the frequency of the energy field can be increased by a suitable amount, such as 0.1%, and the effect of that increase on the measured reflected signal can be used to determine whether to further increase or decrease the energy field frequency. In this exemplary embodiment, where the measured reflected signal decreases with an increase in energy field frequency, the frequency of the energy field can be decreased to determine whether the reflected signal increases. Increases or decreases can then be continued until a maximum is reached. The step size of the energy field frequency increase or decrease can also be increased or reduced, such as where an increase and a decrease both result in a reduction in the measured reflected signal, which indicates that the step size may be too large, or where the amount of increase in the reflected signal accelerates, which indicates that a larger step size can be used to accelerate identification of the resonant frequency. When a maximum in the reflected signal is reached, the frequency of the energy field can be maintained at that value, so as to result in increased energy transfer to the target.

Weapon location display system 210 generates a display showing the size and location of detected weapons. In one exemplary embodiment, weapon location display system 210 can generate a map showing the location of a user relative to detected weapons, so as to allow a user to determine the location of detected weapons, such as in an urban setting where buildings or other structures obscure a direct line of sight to the weapons. Weapon location display system 210 can generate different icons representing the relative size of detected weapons, can identify the type of weapon where positive identification is obtained, can generate a user-controllable icon that allows a user to indicate the targets that should be illuminated by the energy field, can identify targets that are being illuminated to avoid inadvertent interference, or can display other suitable information. Weapon location display system 210 can also generate icons indicating previous locations of weapons or detected targets, so as to allow an operator to determine whether the targets have remained stationary, which may indicate targets that are in storage or that do not have enemy personnel nearby.

Remote display interface system 212 allows a remote display to receive information on the location, size and other parameters for detected weapons. Remote display interface system 212 allows a user to transmit commands to radar weapon detection system, such as to manually direct placement of an energy field, to initiate automatic scanning of a location with the energy field, to provide weapon or ammunition identification data if visual observation of the weapon or ammunition is obtained, or to provide other suitable commands or data.

Weapon tracking system 214 receives weapon location data and tracks movement to reduce false detections, weapons depots, stored weapons, or other reduced importance targets. In one exemplary embodiment, a plurality of potential weapons may be detected, which can include weapon-sized objects that are not weapons. By tracking potential targets that are in motion, the reliability of detection can be improved, as a weapon that is being used is more likely to be in motion than structural components, piping, or other items that may generate a false indication. In another exemplary embodiment, a score can be assigned to different types of motions, such as repetitive motions that indicate a weapon that is being carried by a patrolling enemy, random motions of a large number of potential targets that indicate a concentration of enemy personnel with weapons, progressive motion indicating movement of an enemy towards a user, or other types of motion.

Resonant decay detection system 216 determines whether a received radar signal is a resonant decay signal. In one exemplary embodiment, a metallic conductor that is excited at a resonant frequency will radiate an associated RF signal, but unlike a radar signal that is a simple reflection of the received signal, the resonant signal will decay exponentially, such that the continued transmission of the RF signal at an exponential decay rate is indicative of a resonant decay signal instead of a radar reflected signal. The resonant frequency can be used to determine the actual size of the metallic conductor, which can be different from the radar cross-section of the metallic conductor. Resonant decay can also vary as a function of the length of time that the metallic conductor has been exposed to the resonant RE field, as the resonant signal can increase over time as long as the metallic conductor is being exposed to the resonant RF field, even though it is also simultaneously radiating at the resonant frequency. The distance to the metallic object can be determined as a function of field strength of the RF signal and resonant length. For example, a metallic conductor exposed to a field of known field strength for a period of time will experience a resonant decay starting from a maximum field strength and lasting until a minimum detection threshold is reached. The time difference ΔT between when the emitted RF signal is terminated and when the detected resonant signal from the metallic conductor begins to fall or decrease can be used to determine the expected distance of the metallic object from the RF source, and the distance can be confirmed by determining the expected field strength of the emitted resonant signal based on the length of time that the metallic object has been exposed to the RF field as well as the expected field strength of the RE field at the metallic object based on the initial determination of distance based on ΔT.

In operation, system 200 allows a radar system to receive and process reflected signals to determine a size and location of detected weapons, to select parameters for ammunition that is used with the detected weapons, and to control an energy field to illuminate the weapons and ammunition with energy so as to cause the metallic components of the weapons and ammunition to be excited at a resonant frequency, causing heating and subsequent damage to the weapon, injury to personnel holding the weapon, or detonation of the ammunition.

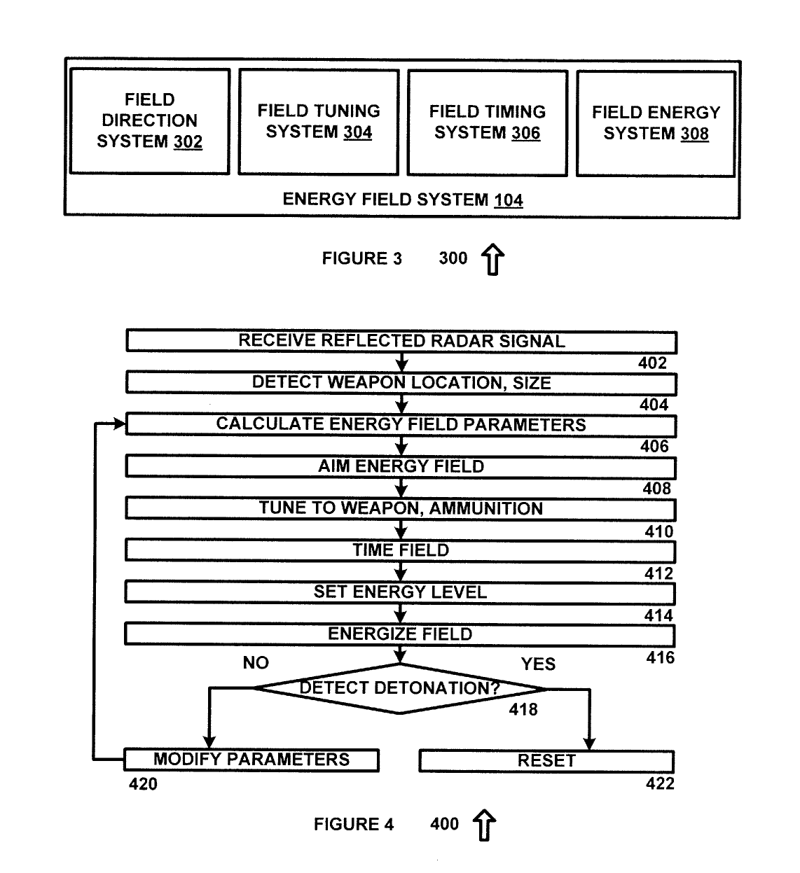

FIG. 3 is a diagram of a system 300 for controlling an energy field in accordance with an exemplary embodiment of the present invention. System 300 includes field direction system 302, field tuning system 304, field timing system 306 and field energy system 308, each of which can be implemented in hardware, software, or a suitable combination of hardware and software, and which can be one or more software systems operating on a general purpose processing platform.

Field direction system 302 receives location data for a weapon and directs an energy field based on the location data. In one exemplary embodiment, field direction system 302 can direct a wide field in single location, can direct a narrower field in a series of locations, or can use other suitable processed for directing an energy field so as to transmit sufficient energy to weapons or ammunition to cause the weapon to heat or the ammunition to detonate. Field direction system 302 can also be used to increase or decrease the field size, move the field within the vicinity of the detected location of the weapon to locate ammunition that is not within a field width of the weapon, change field shape parameters, or otherwise control the direction, size and shape of an energy field. Field direction system 302 can also allow a user to manually control placement of the energy field, to assign a priority to targets, or to provide other suitable commands.

Field tuning system 304 controls a frequency of an energy field. In one exemplary embodiment, the frequency of an energy field can be set to resonate a weapon based on the detected size of the weapon, ammunition based on an expected size of a shell, casing or other metallic components of the ammunition, or other suitable structures. Field tuning system 304 can also receive feedback from radar weapon detection system 102, such as where the frequency of the energy field is adjusted and the reflected signals are monitored to determine whether the weapon or ammunition is being excited at a resonant frequency.

For example, the resonant frequency along the length of a shell having a length of 10 millimeters is 300000000/0.01 or 30 GHz, the resonant frequency of a grenade having a length of 20 centimeters on a rocket propelled grenade is 300000000/0.2 or 1.5 GHz, and the resonant frequency of a rifle barrel having a length of one meter is 300000000/1 or 300 MHz. Additional resonant modes also exist in other dimensions, and the optimal resonant mode can be determined by varying the frequency of the energy field and measuring the reflected signal until it reaches a maximum. In this manner, the initial frequency for the energy field can be based on known ammunition dimensions that correlate to the size of the detected weapon, which will typically be easier to detect from the radar data than the ammunition, and the frequency of the energy field can be varied to maximize the energy transferred to the ammunition in the vicinity of the weapon. Likewise, where obstructions absorb transmitted energy at certain frequency ranges, the frequency of the energy field can be adjusted so as to avoid such frequency ranges to increase the amount of energy delivered to weapons, ammunition, or other suitable structures.

Field timing system 306 generates energy field timing characteristics. In one exemplary embodiment, an energy field may be able to run for a predetermined period of time based on system parameters, available energy, or other suitable parameters, such that the length of time that the energy field will be allowed to operate is controlled so as not to deplete the energy source or damage the field generation system. Likewise, where detected weapons or ammunition have been illuminated for a sufficient length of time to cause heating, damage or detonation, field timing system 306 can terminate operation of the energy field so as to conserve energy. For example, an energy field transmitting 100 kilowatts of energy in a 100 square centimeter area circle at the expected location of a weapon and ammunition will deliver up to 1000 watts per square centimeter of energy to the weapon or ammunition at that location. The expected time for the weapon or ammunition to experience a rise in temperature sufficient to render the weapon inoperable, to damage the weapon, to cause injury to personnel holding the weapon, to ignite the primer or charge, or to otherwise render the weapon or ammunition inoperative can be determined analytically or experimentally, and the length of time that the field is allowed to illuminate a location can be set based on a multiple of the expected time to cause detonation.

Field energy system 308 controls an amount of energy that is transmitted by an energy field. In one exemplary embodiment, where the energy field is illuminating near field targets, the amount of energy can be decreased, whereas when far field components are being illuminated, the amount of energy can be increased. Likewise, the amount of energy can be based on the size of the field at the point of illumination, the size of the field can be maximized based on available energy, or other suitable processes can also or alternatively be used.

In operation, system 300 is used to control energy field parameters so as to generate an energy field that causes illuminated weapons or ammunition to resonate and generate heat so as to cause the weapon to be rendered inoperable or to cause the ammunition to detonate.

FIG. 4 is a diagram of method 400 for detecting and heating weapons and ammunition in accordance with an exemplary embodiment of the present invention. Method 400 begins at 402, where a reflected radar signal is received. The reflected radar signal is then analyzed at 404 to determine a weapon location, size, or other suitable parameters. In one exemplary embodiment, the strength of the reflected signal, the wave form of the reflected signal, the time between the transmission of the radar signal and the reception of the reflected signal or other suitable parameters can be measured and analyzed to determine a weapon size, location, and to differentiate between objects made of weapons material and non-weapon objects. Likewise, relative motion of potential targets can be used to distinguish between actual targets and objects that resemble targets, between active targets and inactive targets, or to otherwise improve the reliability of detection. The method then proceeds to 406.

At 406, energy field parameters are calculated. In one exemplary embodiment, the resonant frequency for a weapon can be calculated, or type of ammunition used with the weapon can be determined from a look-up table storing associated ammunition types, and the frequency of the energy field can be selected based on the resonant frequency. Likewise, the area of the energy field at the location of the weapon can be selected to ensure that the amount of energy provided to the weapon or ammunition is sufficient to cause the weapon to be damaged or the ammunition to ignite. The method then proceeds to 408.

At 408, the energy field is aimed at the expected location of the weapon or ammunition, such as by selecting phased array parameters, by mechanical alignment, or in other suitable manners. The method then proceeds to 410.

At 410, the energy field is tuned to maximize energy transfer to the weapon, the ammunition, or other suitable objects. In one exemplary embodiment, the frequency of the energy field can be increased or decreased and the reflected signal can be measured to determine whether the amount of energy being received and radiated by illuminated objects is increasing or decreasing. When it is determined that the energy has been maximized, or when it is otherwise determined that frequency of the energy field has been optimized, the method proceeds to 412.

At 412, a length of time for illumination is determined. For example, where it is determined that the weapon or ammunition that is at the location of the field should reach a temperature at which damage or detonation should occur within a time period X, the field can be focused on the area under illumination for a predetermined period of time, such as 2X, 3X, or other suitable times. The method then proceeds to 414.

At 414, the energy level of the energy field is set. In one exemplary embodiment, where the maximum available energy is not being provided, the energy level can be increased to the maximum available energy. Likewise, the energy level can be set based on available energy reserves, mission time, or other suitable parameters. The method then proceeds to 416.

At 416, the field is energized, if the field has not already been energized. The method then proceeds to 418.

At 418, it is determined whether detonation has been detected, such as by a decrease in the reflected energy from the weapon or ammunition, from visual or audio reports, or in other suitable manners. If detonation has not been detected, the method proceeds to 420, where field parameters are modified, such as by changing the location of the field, the frequency, the energy, or other suitable parameters. The method then returns to 406. Likewise, if it is determined that detonation has been detected, the proceeds to 422 where the system is reset to locate other weapons.

In operation, method 400 allows hidden weapons to be detected and illuminated with an energy field so as to damage the weapon, detonate ammunition in the location of the weapon, or to otherwise render the weapon inoperative. Method 400 adjusts the frequency of the energy field to match a resonant frequency of the weapon or ammunition so as to maximize the amount of energy that is transferred to the weapon or ammunition, to reduce the amount of time required to damage the weapon or detonate ammunition. Certain of the exemplary steps of method 400 can omitted where suitable, such as energizing the field after tuning instead of during tuning, setting a time for the field, using a maximum energy instead of setting the energy level, or other suitable steps can be omitted. Likewise, the energy field can be used in a search mode, where radar location of a weapon is used to locate an initial search location and where the energy field is scanned within a predetermined pattern.

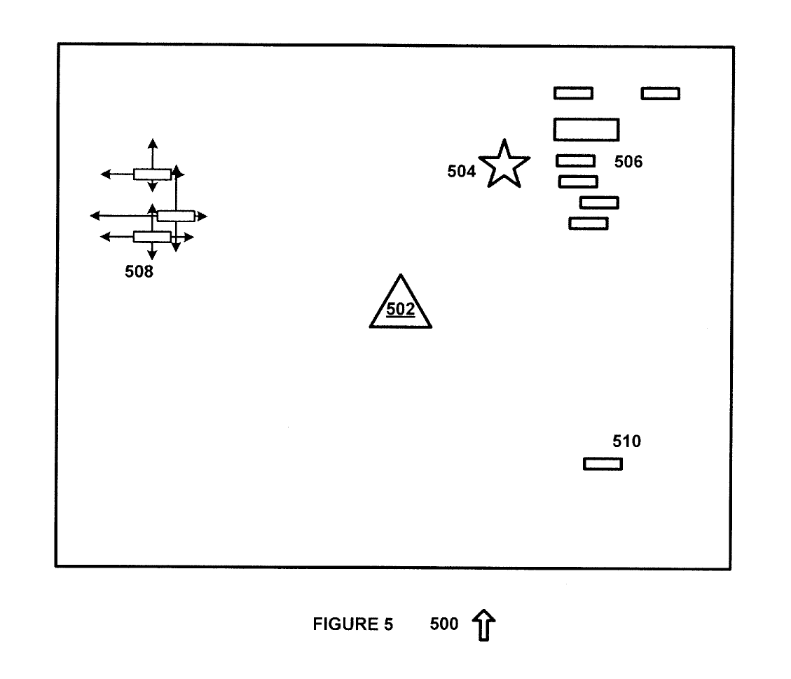

FIG. 5 is a diagram of a map 500 identifying the location of weapons relative to the location of friendly forces in accordance with an exemplary embodiment of the present invention. Map 500 includes location icon 502, which indicates the location of friendly troops, the user of a remote weapon display system 114, or other suitable non-hostile parties. Selection icon 504 allows a user to see where an energy field is currently focused, and can also allow a user to move selection icon 504 so as to place selection icon 504 on a target of interest, such as a target where the user is attempting to gain access, a target with the greatest concentration of weapons, or other suitable targets. Threat icons 506, 508 and 510 present a graphic display of the size and number of detected weapons. As shown in exemplary map 500, the largest number of detected weapons is associated with threat icon 506, which also shows one weapon that is larger than other weapons associated with threat icon 506. Based on the information provided to a user, a decision can be made to illuminate the area of threat icon 506 first, and the size and type of weapons can be used to select energy field parameters. Likewise, a user can provide weapon and ammunition type data if visual surveillance of the threat is obtained and the weapons and ammunition are identified, so as to improve the efficacy of the field energy in causing detonation of ammunition.

Threat icon 508 includes arrow indicators that can be used to determine the change in position of the detected target objects. In this exemplary embodiment, the lack of associated position change indicators for threat icons 506 and 510 can be used to indicate that the targets associated with threat icon 508 have associated enemy personnel carrying the detected target objects, whereas the stationary positions of threat icons 506 and 510 indicate that the associated target objects are inactive, in storage, or otherwise do not have associated enemy personnel nearby. In this manner, an operator does not need to watch map 500 to determine whether detected target objects have been remaining stationary, so as to allow the operator to select target objects with associated personnel and to avoid target objects that are not a present threat.

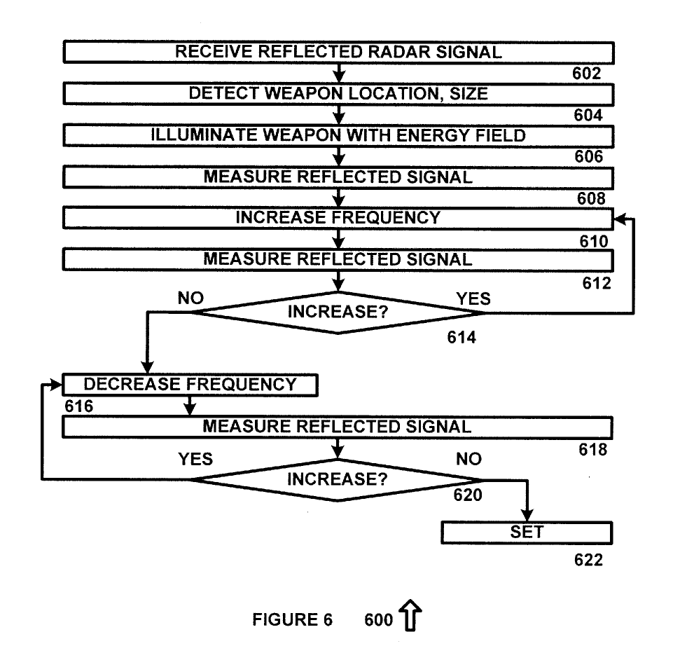

FIG. 6 is a flow chart of a method 600 for tuning an energy field to a resonant frequency of a target in accordance with an exemplary embodiment of the present invention. Method 600 begins at 602, where a reflected radar signal is received. The method then proceeds to 604, where the radar signal is processed to detect a weapon location and size. In one exemplary embodiment, the reflected signal can be processed in a digital domain, and frequency components of the reflected signal can be used to determine characteristics of the objects creating the reflected signal. Objects have size, material or other characteristics that exclude them from being potential weapons can be excluded, reflections can be eliminated or used to confirm object sizes and locations, or other suitable processes can be used. The method then proceeds to 606.

At 606, one or more detected weapons are illuminated with an energy field, such as by determining an expected resonant frequency of the detected weapons. The method then proceeds to 608, where a reflected signal from the illuminated objects is received. In one exemplary embodiment, and frequency components of the reflected signal can be used to confirm the identity of the objects creating the reflected signal. The method then proceeds to 610.

At 610, the frequency of the energy field is increased, such as by a predetermined amount, an amount calculated based on prior increases, or in other suitable manners. The method then proceeds to 612 where the reflected signal is measured. Because the frequency of the energy field has changed, the reflected signal may require additional analysis to exclude objects or to re-acquire the location or orientation of the weapon. The method then proceeds to 614 where it is determined whether the reflected signal has increased. In one exemplary embodiment, where an energy field is close to a resonant frequency of an object that is being illuminated by the energy field, a reflected signal from the object may increase in energy at a detected frequency or at other frequencies as the frequency of the energy field approaches a resonant frequency of the object. If it is determined that the reflected signal has increased, the method returns to 610, otherwise the method proceeds to 616.

At 616, the frequency of the energy field is decreased, such as by a predetermined amount, an amount based on previous changes to the frequency of the energy field, or other suitable amounts. The method then proceeds to 618 where the reflected signal is measured, such as by detecting frequency components and an associated magnitude of frequency components, by processing the signal to exclude non-weapon objects or to re-acquire the detected object, or in other suitable manners. The method then proceeds to 620.

At 620, it is determined whether the reflected signal has increased. In one exemplary embodiment, where an energy field is close to a resonant frequency of an object that is being illuminated by the energy field, a reflected signal from the object may increase in energy at a detected frequency or at other frequencies as the frequency of the energy field approaches a resonant frequency of the object. If it is determined that the reflected signal has increased, the method returns to 616, otherwise the method proceeds to 622.

At 622, the frequency of the energy field is set to the frequency that provided the greatest reflected signal, such as where the frequency indicates that the energy field is exciting a resonant mode of a detected weapon.

In operation, method 600 allows an energy field to be tuned to a resonant frequency of a detected weapon, such as to maximize energy transfer to the weapon so as to cause damage to the weapon, ignition of ammunition, or other suitable effects.

FIG. 7 is a flow chart of a method 700 for tracking a location of a weapon in accordance with an exemplary embodiment of the present invention. Method 700 begins at 702, where a reflected radar signal is received. In one exemplary embodiment, the reflected radar signal can be transformed from a time to a frequency domain and frequency components of the reflected signal can be determined, such as by performing a fast Fourier transform of the signal or in other suitable manners. The method then proceeds to 704.

At 704, weapon locations and orientations are determined from the radar signal and stored, such as by excluding objects that have dimensions that do not match weapon dimensions, by using reflected signals to confirm the location, size, orientation or other characteristics of objects reflecting the radar signal, or in other suitable manners. The method then proceeds to 706.

At 706, a reflected radar signal is received. In one exemplary embodiment, the reflected radar signal can be transformed from a time to a frequency domain and frequency components of the reflected signal can be determined, such as by performing a fast Fourier transform of the signal or in other suitable manners. The method then proceeds to 708.

At 708, weapon locations and orientations are determined from the radar signal and stored, such as by excluding objects that have dimensions that do not match weapon dimensions, by using reflected signals to confirm the location, size, orientation or other characteristics of objects reflecting the radar signal, or in other suitable manners. The method then proceeds to 710.

At 710, it is determined whether a change has occurred in the weapon location or orientation. In one exemplary embodiment, stored weapon location, orientation or other suitable data can be compared to determine whether a change has occurred. If it is determined that no change has occurred, the method returns to 706. Otherwise, the method proceeds to 712 where the change is stored, such as on a map to allow the change in location to be tracked and analyzed. The method then proceeds to 714.

At 714, the direction of a change is processed. In one exemplary embodiment, directions can be given priority, such as when a first mode of operation is used to give priority to targets that are approaching a location, a second mode of operation is used to give priority to targets that are receding from a location, a third more of operation is used to give priority to targets that are moving in a pattern that represents deployment of forces, or in other suitable manners. The method then proceeds to 716.

At 716, it is determined whether to change a rank associated with a target. In one exemplary embodiment, targets can be ranked based on a threat rating, such as where the rank is used to generate a display, to target an energy field, or in other suitable manners. If it is determined that the rank of a target is to be changed, the method proceeds to 718 where a change in a target rank is generated. The method then returns to 706. Otherwise, if no change of rank is determined at 716, the method returns to 706.

In operation, method 700 allows target locations to be tracked and ranked, so as to identify active targets from passive targets, to assist with threat assessment, to assist with target selection for an energy field, or for other suitable purposes.

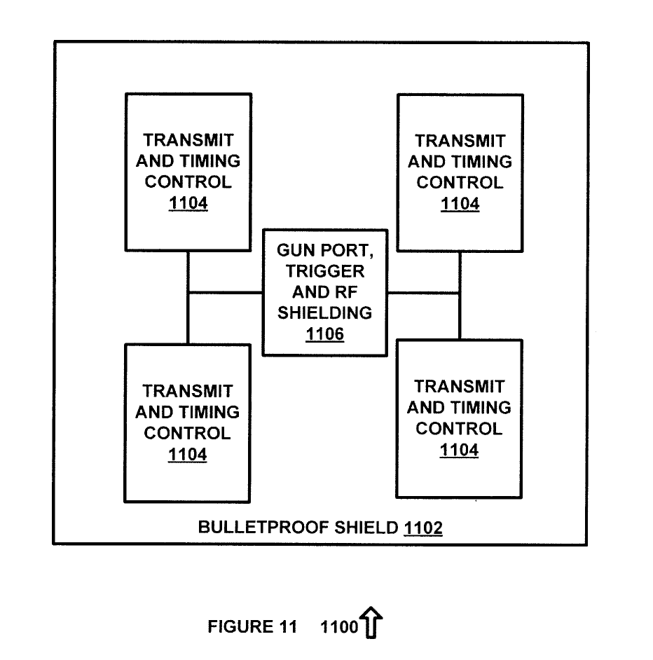

FIG. 11 is a diagram of an active shield 1100 in accordance with an exemplary embodiment of the present invention. Active shield 1100 includes transmit and timing control units 1104, which are used to detect the resonant frequency of a weapon and transmit RF energy to cause generation of voltages or other weapon damaging effects. Transmit and timing control units 1104 are coupled to bulletproof shield 1102, which can be clear, opaque, opaque with clear viewing ports, or otherwise constructed of Plexiglas, Kevlar or other suitable bulletproof materials. Gun port, trigger and RE shielding 1106 is provided to allow a user to grip active shield 1100, to active the transmit and timing control units 1104, and if necessary, to fire a gun or other weapon, with RF shielding for the user's weapon to prevent the inadvertent risk of a shock to the user. In this manner, a handheld active shield is provided that allows an assailant to be disarmed and that also allows the user to use a weapon, such as if the assailant approaches the user or has a non-conducting weapon such as a wooden club.

Transmit and timing control units 1104 also control the length of time that an RF signal can be generated as a function of the frequency of the RF signal. In particular, certain frequencies of RF signals can cause serious health effects with prolonged exposure, such as generation of cataracts and heating of internal organs. Transmit and timing control units 1104 can be used to limit the length of time that an RF signal is generated to prevent inadvertent overexposure of persons to RF fields. Transmit and timing control units 1104 are oriented so as to concentrate the RF signal at the location of the weapon, such as by use of a phased array or in other suitable manners, so as to reduce exposure of the person holding the weapon to the RF signal and to reduce the exposure of bystanders to the RE signal. In one exemplary embodiment, the RF signal can be a high-frequency RF signal that does not penetrate more than several millimeters into a person's body, so as to generate personal discomfort and without regard to the resonant frequency of any weapon the person may be holding.

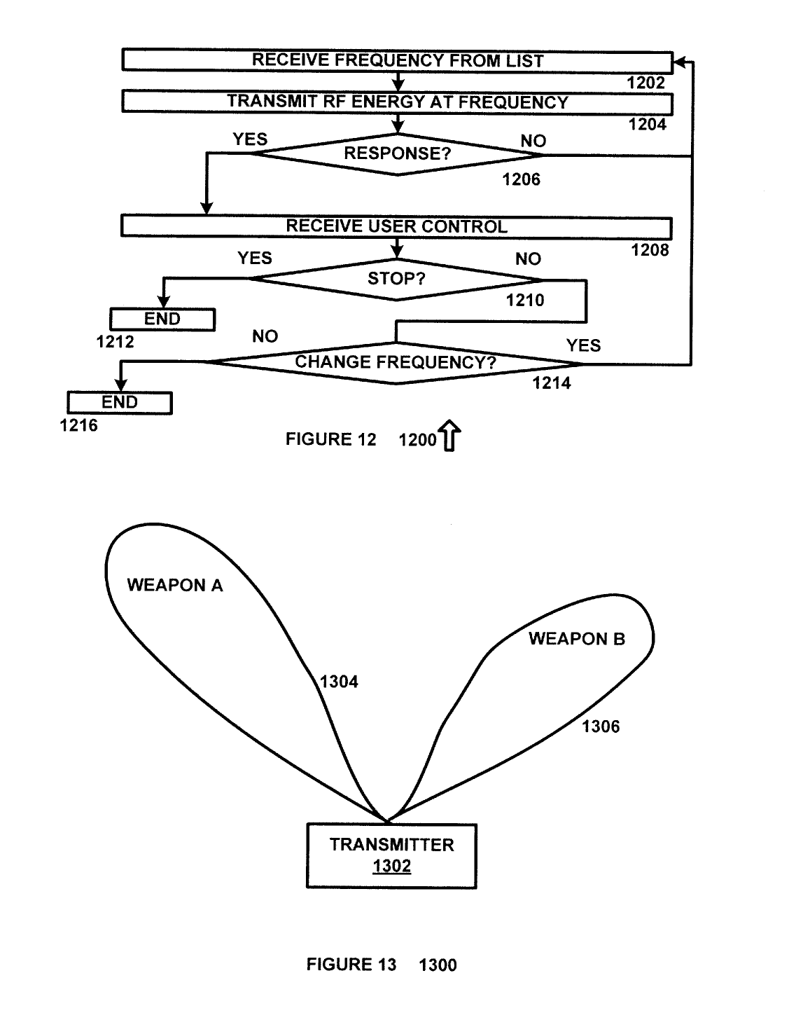

FIG. 12 is a diagram of a method 1200 for frequency searching in accordance with an exemplary embodiment of the present invention. Method 1200 begins at 1202, where a frequency is received or extracted from a list of known resonant frequencies. In one exemplary embodiment, common weapons can be tested in advance and resonant frequencies that are effective for certain purposes, such as disarming a person holding the weapon or creating voltage differentials that cause ammunition in a magazine or chamber to ignite, can be identified and stored in a file or list. One or more of these frequencies can be extracted, depending on the power available and number of frequencies that can be generated by the transmitter, and the transmitter can be controlled to transmit the extracted frequency at 1204. The method then proceeds to 1206.

At 1206, it is determined whether a response has been received. In one exemplary embodiment, the response can be determined by receiving RF signals and determining whether a resonant frequency has been detected, such as by measuring a resonant decay at the target resonant frequency. In another exemplary embodiment, the response can be a user control signal, such as by providing a “search” function button/trigger that allows the user to cause a transmitter to search frequencies until the user observes an effect on the target weapon, at which point the user can change the state of the search function button/trigger or perform other actions. If it is determined that a response has not been received, the method returns to 1202 where a new frequency or frequencies are selected. Otherwise, the method proceeds to 1208.

At 1208, a user control is received. In one exemplary embodiment, a number of different user controls can be provided using a number of different toggle switches, a multiple position switch, different button/triggers, or other suitable devices. The method then proceeds to 1210, where it is determined whether a stop control has been received. In one exemplary embodiment, the stop control can be a positive control signal, the termination of a control signal, or other suitable stop controls. If a stop control has been received, the method proceeds to 1212 and terminates. Otherwise, the method proceeds to 1214.

At 1214, it is determined whether a change frequency control has been received. In one exemplary embodiment, the change frequency control can be generated by a user selecting a switch or other device. In another exemplary embodiment, a timer can be used to change frequencies, a search algorithm can be used, or other suitable devices can be used to generate a change frequency control. If it is determined that a change frequency control has been received, the method returns to 1202, otherwise the method proceeds to 1216 and terminates.

In operation, method 1200 allows predetermined and known resonant frequencies to be used to be searched to identify a resonant frequency for a weapon or other device. The search algorithm can be used to quickly find and detect weapons, such as when there are several hundred potential resonant frequencies of interest and the transmitter can transmit a test signal of short duration, such as 100 microseconds. In this exemplary embodiment, several hundred frequencies can be searched in less than one second. For transmitters where multiple frequencies can be generated, the search time can be further reduced.

FIG. 13 is a diagram of a multiple beam pattern 1300 in accordance with an exemplary embodiment of the present invention. Multiple beam pattern 1300 is generated by transmitter 1302, which can be one or more transmitters in a predetermined or configurable mounting device, a beam forming phased array, or other suitable devices. Two lobes, 1304 and 1306 are generated, so as to focus the radiated energy on weapon A and weapon B, respectively. In this exemplary embodiment, if multiple weapons have been detected, the locations of those weapons can be used to modify the beam pattern, such as by relocating or reconfiguring the discrete transmitter array, by using a beam-forming phased array with multiple beam capability, or in other suitable manners.

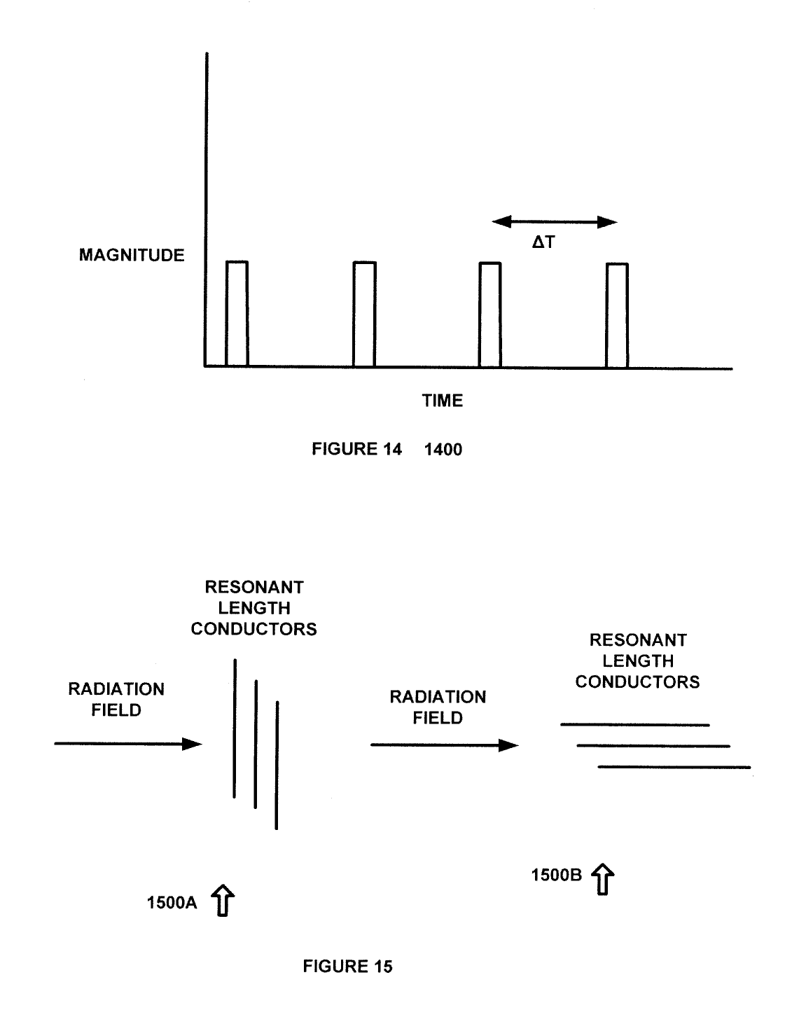

FIG. 14 is a diagram of a shock frequency timing diagram 1400 in accordance with an exemplary embodiment of the present invention. In one exemplary embodiment, field timing system 306 or other suitable systems can be used to control the field to generate a series of pulses, such as where a voltage capable of delivering a shock to a person holding a weapon builds up relatively quickly, such as where a high frequency signal is used to induce a resonant standing wave voltage. In this exemplary embodiment, the induced voltage might be delivered at a frequency that is too high to induce a nerve reaction, which may require a frequency below several thousand hertz. If the delivered voltage is not at a sufficient magnitude or if the person holding the weapon has a high tolerance to electrical shock, then an uninterrupted high frequency voltage might not cause the person to drop the weapon, whereas delivering a lower frequency series of shocks can be used to induce a muscle spasm that forces the person holding the weapon to drop the weapon or to otherwise be able to operate the weapon. Likewise, frequencies such as ones that may cause ventricular fibrillation, may be avoided so as to avoid causing a lethal effect to the person holding the weapon.

FIG. 15 is a diagram of two exemplary experimental embodiments of the present invention that demonstrate the inventive concept. In 1500A, resonant length conductors were exposed to a radiation field having a conductive dimension at a right angle to the field vector, and where no electrical effects were observed after 20 second of exposure at field strengths of several hundred volts per meter. In 1500B, resonant length conductors were exposed to a radiation field having a conductive dimension in series with the field vector, and electrical sparking effects and heating were observed almost instantaneously upon exposure to field strengths of several hundred volts per meter. In addition, combinations of resonant length and non-resonant length conductors were also used with similar results, which suggests that the interactions between adjacent conductors can create field effects that generate standing waves and amplification of induced voltages. In this exemplary embodiment, the frequency was approximately 2.4 GHz, the field strength was approximately several hundred volts/meter in a sealed microwave chamber, and the resonant length conductors were both solid and stranded 12 gauge wire as well as copper tubing, where the resonant length was approximately 12.5 centimeters. Electrical effects such as sparking would not normally occur at field strengths of several hundred volts per meter, which further suggest that amplification was occurring due to resonance in the conductors. It is interesting to note that there was no sparking or other electrical effects observed in the 1500A configuration after an extended period time (20 seconds), whereas the sparking and electrical effects were observed in the 1500B configuration within several seconds or almost instantaneously.

These experimental results indicate that the strongest resonant response may occur for conductors that are oriented in series with the radiated field, and that increasing the angle of the conductor relative to the radiated field may decrease the resonant response, including the resonant field that is generated by the conductor (which decays exponentially). For a conductor that is in phase with the radiated field, the resonant field generated by the conductor would be at a right angle to the source of the field, which would require any return signals generated by the conductor in its resonant state to be determined from either a reflection, or from a receiver antenna located at a different location from the radiator antenna. The normalized decay signal from the excited resonant conductor can also be used to determine the angle at which the conductor is oriented towards the field source, as well as the distance. In this manner, detection and processing of the resonant signal from a conductor can be used to determine both the size, location and orientation of the conductor.

In addition, the ability to generate electrical effects from adjacent conductors of different and non-resonant lengths indicates that the use of phase-oriented microwave radiation can be used to induce destructive electrical effects in complex weapon systems or groups of weapons even where the resonant frequency cannot be readily determined. For example, a missile will normally have a length ranging from a meter to several meters, and will include wiring systems having various conducting component lengths, such that the use of a MASER or other microwave radiation source aimed in phase with an incoming missile and having a suitable RF frequency that is close to the resonant frequency of one or more conductors within the missile could induce electrical effects from inductively coupled, capacitively coupled or other reflective pathways that cause the missile systems to be disrupted or destroyed. Likewise, groups of weapons such as rifles and rocket launchers in close formation could also provide inductively coupled, capacitively coupled or other reflective pathways that generate electrical effects that damage the weapons or prevent them from being used. In this exemplary embodiment, a conventional system for detecting the location of an incoming missile or other weapon or groups or weapons could be used, including but not limited to conventional (non-resonant) radar or visual detection systems, and the microwave radiation source could be aimed at the incoming missile or other weapon or groups of weapons in series with the radiated field, so as to maximize the inductively coupled, capacitively coupled or other reflective pathways that generate electrical effects that damage the weapons or prevent them from being used. Such systems could be effectively deployed on an aircraft and could be used when an incoming missile as been detected, or from ground based locations.

Although exemplary embodiments of a system and method of the present invention have been described in detail herein, those skilled in the art will also recognize that various substitutions and modifications can be made to the systems and methods without departing from the scope and spirit of the appended claims.

What is claimed is:

1. A system for causing an electrical effect in a weapon comprising:
a system for detecting a location and a size of a weapon; and
a system for transmitting electromagnetic radiation towards the weapon at a frequency and a vector orientation to optimize generation of electrical effects in the weapon.

2. The system of claim 1 wherein the system for detecting the location and the size of the weapon determines the size of the weapon based on a resonant frequency of the weapon.

3. The system of claim 1 wherein the system for transmitting the electromagnetic radiation towards the weapon at the frequency and the vector orientation to optimize the generation of electrical effects in the weapon selects the frequency based on the size of the weapon.

4. The system of claim 1 further comprising a field direction system receiving the plurality of energy field parameters and controlling the location of the transmitted energy.

5. The system of claim 1 further comprising a field tuning system receiving the plurality of energy field parameters and controlling a frequency of the transmitted energy.

6. The system of claim 1 further comprising a field timing system receiving the plurality of energy field parameters and controlling a transmission time of the transmitted energy.

7. The system of claim 1 further comprising a field energy system receiving the plurality of energy field parameters and controlling an energy setting of the transmitted energy.

8. The system of claim 1 further comprising:
a bullet-proof shield; and
the system for transmitting electromagnetic radiation coupled to the bullet-proof shield and oriented to concentrate transmission of the electromagnetic radiation towards the weapon.

9. A method for generating electric effects in weapons comprising:
determining a vector that is in phase with a conducting structure of weapon; and
transmitting electromagnetic radiation having a frequency that will excite a resonant mode of oscillation at the weapon in a direction based on the vector.

10. The method of claim 9 further comprising receiving resonant signal data and determining a vector correction.

11. The method of claim 9 further comprising receiving resonant signal data and determining a size of the weapon.

12. The method of claim 9 further comprising controlling a location of an energy field based on a plurality of energy field parameters.

13. The method of claim 9 further comprising controlling a frequency of the transmitted energy based on a plurality of energy field parameters.

14. The method of claim 9 further comprising selecting a frequency of the transmitted energy based on an ammunition size associated with the weapon.

15. The method of claim 9 further comprising:
generating a display showing the location of two or more weapons; and
receiving a command to direct the transmitted energy to one of the two or more weapons.

16. A system for disarming weapons comprising:
a bullet-proof shield; and
an energy field system coupled to the bullet-proof shield for transmitting RF energy at a location associated with a weapon.

17. The system of claim 16 wherein the energy field system generates RF energy at a resonant frequency of the weapon.

18. The system of claim 16 wherein the bullet-proof shield comprises a viewing port.

19. The system of claim 16 wherein the bullet-proof shield comprises a weapon port to allow an operator of the bullet-proof shield to extend a defensive weapon through the bullet-proof shield.

20. The system of claim 16 further comprising a timing system for limiting an exposure time of the RE energy to prevent injury to personnel.
